(19) United States
(12) Patent Application Publication
(10) Pub. No.: US 2025/0156929 A1
(43) Pub. Date: May 15, 2025

(54) Sustainable Modular Mattress System With Subscription Service

(71) Applicant: IndraTech LLC, Troy, MI (US)

(72) Inventor: Surendra KHAMBETE, Bloomfield Hills, MI (US)

(73) Assignee: IndraTech LLC, Troy, MI (US)

(21) Appl. No.: 18/941,510

(22) Filed: Nov. 8, 2024

Related U.S. Application Data
(60) Provisional application No. 63/597,393, filed on Nov. 9, 2023.

(51) Int. Cl. G06Q 30/0601; A47C 27/00; A47C 27/06; A47C 27/12; A47C 31/00

(52) U.S. Cl. CPC G06Q 30/0633; A47C 27/007; A47C 27/063; A47C 27/12; A47C 31/001; A47C 31/007

(57) ABSTRACT

A bedding system subscription service that includes providing a selection of mattress cores from which a customer can select for purchase; providing a selection of mattress covers from which the customer can select for use in combination with the selected mattress core; periodically replacing the selected mattress cover with a new mattress cover; and recycling the selected mattress cover after it has been replaced by the new mattress cover.

### CROSS-REFERENCE TO RELATED APPLICATIONS

This application claims the benefit of U.S. Provisional Application No. 63/597,393, filed on Nov. 9, 2023. The entire disclosure of the above application is incorporated herein by reference.

### FIELD

The present disclosure relates to a sustainable modular mattress system with a subscription service.

### BACKGROUND

This section provides background information related to the present disclosure which is not necessarily prior art.

Mattress technology has evolved from mattresses that include traditional springs, to mattresses that are formed of memory foam, to mattresses that may be a hybrid of a mattress including traditional springs and memory foam. Regardless of the construction of the mattress, the sleep quality and comfort of the mattress will decline as the mattress ages. Further, these types of mattresses do not breathe well, may include a number of chemicals, and are very difficult to recycle because the components of the mattress cannot or are very difficult to be separated and recycled. Indeed, disposal of mattresses is becoming an ever-increasing problem considering that ninety million mattresses are deposited in landfills each year in the United States alone. Accordingly, it is desirable that mattress technology further evolve to reduce waste while increasing sleep quality and comfort.

### SUMMARY

This section provides a general summary of the disclosure, and is not a comprehensive disclosure of its full scope or all of its features.

According to an aspect of the present disclosure, the present disclosure provides a bedding system subscription service that may include providing a selection of mattress cores from which a customer can select for purchase; providing a selection of mattress covers from which the customer can select for use in combination with the selected mattress core; periodically replacing the selected mattress cover with a new mattress cover; and recycling the selected mattress cover after it has been replaced by the new mattress cover.

According to the aspect, the step of periodically replacing the selected mattress cover with the new mattress cover includes shipping the new mattress cover to the customer after the selected mattress cover has been in use for a predetermined period of time.

According to the aspect, the shipping the new mattress cover to the customer further comprises shipping a return package to the customer with the new mattress cover for the customer to return the selected mattress cover for recycling.

According to the aspect, the predetermined period of time is six months, one year, eighteen months, or two years.

According to the aspect, the subscription service may also include sending a reminder to the customer in advance of periodically replacing the selected mattress cover with the new mattress cover.

According to the aspect, the selection of mattress cores and the selection of mattress covers include mattress cores and mattress covers that are entirely recyclable.

According to the aspect, the selection of mattress cores and the selection of mattress covers include mattress cores and mattress covers that are formed of recycled materials.

According to the aspect, the mattress cores include a plurality of individual spring assemblies that each including a spring enveloped in a sleeve.

According to the aspect, the plurality of individual spring assemblies include first spring assemblies having a first axial length, second spring assemblies having a second axial length, and third spring assemblies having a third axial length, wherein the first axial length is greater than the second axial length, and the second axial length is greater than the third axial length.

According to the aspect, each spring is formed of a recycled metal material and each sleeve is formed of a recycled polymeric material.

According to the aspect, the mattress covers each include a backing layer, a comfort layer, and a covering layer that are each recyclable.

According to the aspect, the comfort layer is formed from a plurality of fibers that are configured to enhance moisture management and increase cooling and breathable properties of the mattress cover.

According to the aspect, the plurality of fibers include hollow elongated fibers and elongated fibers that include a plurality of lobes that extend along a length of the elongated fibers.

According to the aspect, a density of the plurality of fibers is tunable to adjust a stiffness of the comfort layer.

According to the aspect, the backing layer is flame retardant and formed of a breathable moisture absorbent material that is recyclable and odor resistant.

According to the aspect, the covering layer is formed of a recyclable polymeric material that is moisture wicking.

According to the aspect, the covering layer is embossed by heating.

According to the aspect, the covering layer further comprises an anti-bacterial and anti-fungal agent.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 illustrates an example bedding system according to a principle of the present disclosure;

FIG. 2 illustrates another example bedding system according to a principle of the present disclosure;

FIG. 3 illustrates an example mattress core that may be part of the bedding system illustrated in FIG. 1;

FIG. 4 illustrates the fibers that may be used in a comfort layer of a mattress cover that can be part of the bedding system illustrated in FIG. 1;

FIG. 5 illustrates different layers that may be attached to form the mattress cover of the bedding system illustrated in FIG. 1;

FIG. 6 is a perspective view of a comfort layer divided into two separate zones having different characteristics that may be part of the mattress cover illustrated in FIG. 1;

FIG. 7 is a perspective view of a covering layer that may be part of the mattress cover illustrated in FIG. 1; and

FIG. 8 is a flowchart depicting an example subscription service for the bedding system illustrated in FIG. 1.

Corresponding reference numerals indicate corresponding parts throughout the several views of the drawings.

### DETAILED DESCRIPTION

Example embodiments will now be described more fully with reference to the accompanying drawings. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

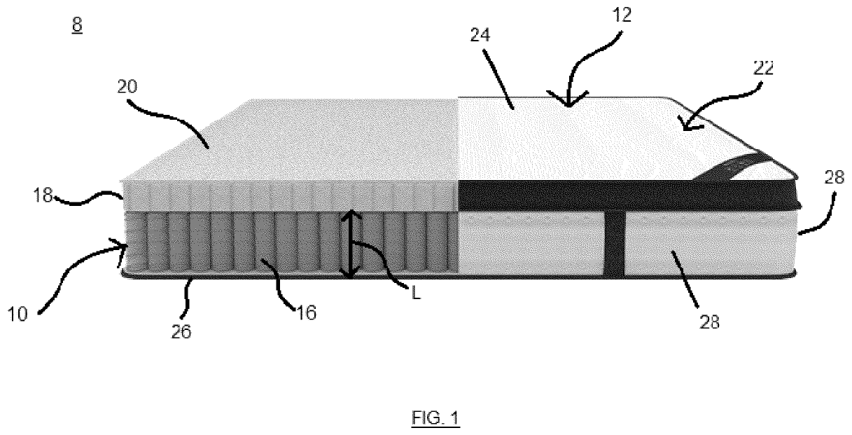

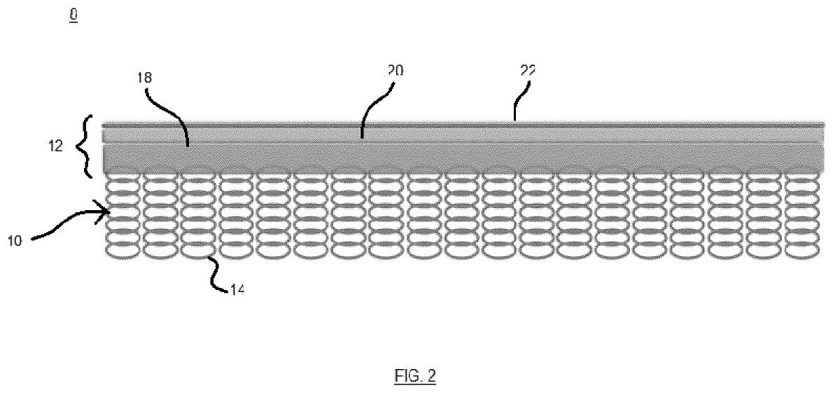

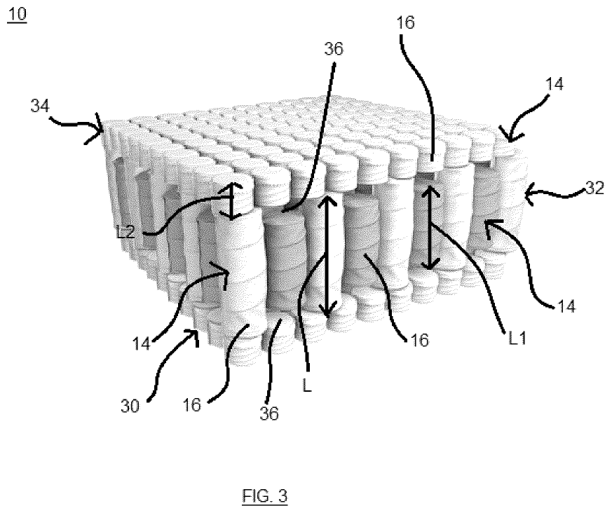

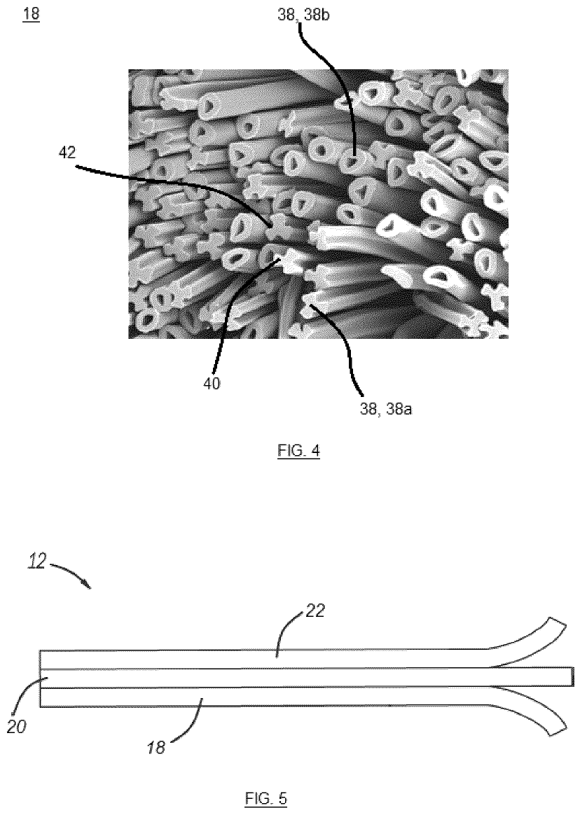

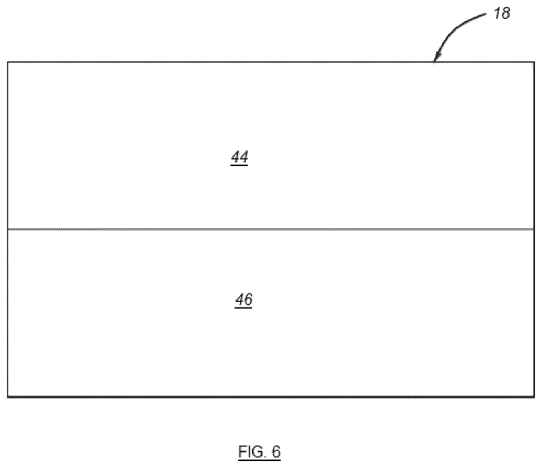

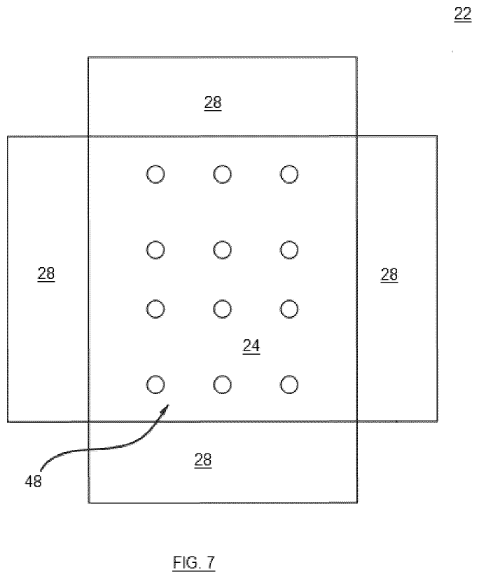

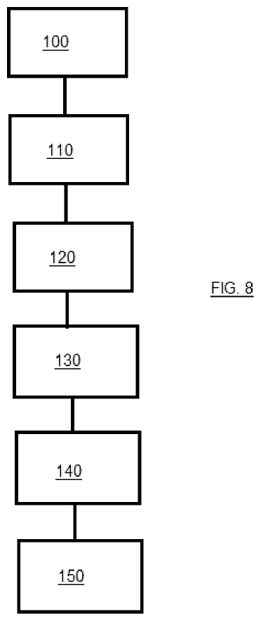

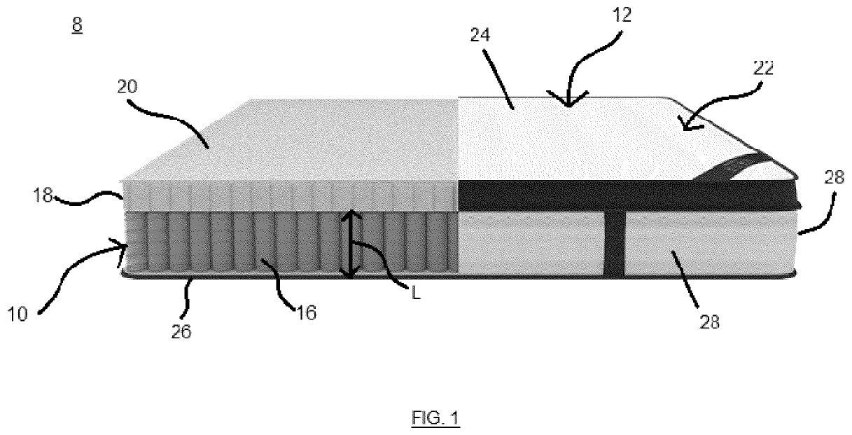

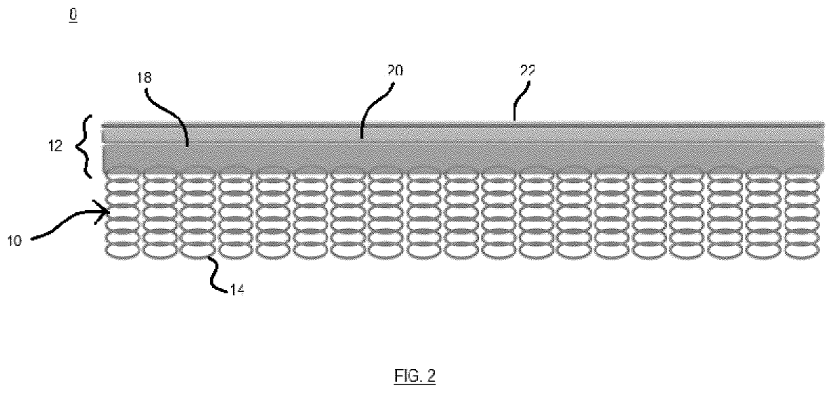

FIGS. 1 and 2 illustrate an example bedding system 8 including a mattress core 10 and mattress topper or cover 12 according to a principle of the present disclosure. In the illustrated embodiment, mattress core 10 includes a plurality of spring assemblies 14 (FIG. 2) that each include a spring 15 formed of a material such as steel that is individually wrapped in a sleeve 16 (FIG. 1) that may be formed of a recyclable polymeric material such as polyethylene or polyester. Cover 12 is configured to surround mattress core 10 and may include a comfort layer 18, a backing layer 20, and a covering layer 22 that may include a top panel 24, a bottom panel 26, and a plurality of side panels 28.

Spring assemblies 14 are positioned with a cavity defined by each of the top panel 24, bottom panel 26, and side panels 28. Spring assemblies 14 may each have the same axial length L as shown in FIG. 1, or mattress core 10 may include a plurality of spring assemblies 14 that have different axial lengths L, L1, and L2 as shown in FIG. 3 where L>L1>L2. In either case, the spring constant of the spring 15 of each spring assembly 14 can be different such that the mattress core 10 can be “tunable,” which means that mattress core 10 can be manufactured according to the customer's desired specifications. For example, one customer may desire a “stiff” mattress core 10, another customer may desire a “soft” mattress core 10, and another customer may desire a mattress core 10 having various zones of stiffness and softness. In any of these scenarios, spring assemblies 14 having the desired spring constant characteristics may be selected for mattress core 10 that can achieve the customer's desired sleep comfort. The tunability of mattress core 10 will be described in more detail later.

In the embodiment illustrated in FIG. 3, mattress core 10 includes a first layer 30 formed of a plurality of spring assemblies 14 having the axial length L2, a second layer 32 formed of a combination of spring assemblies 14 having the axial length L and the axial length L1, and a third layer 34 formed of a plurality of spring assemblies 14 having the axial length L2. The first and third layers 30 and 34 may be designed to compress to a greater extent (i.e., have springs 15 having the lowest spring constant) in comparison to the spring assemblies 14 having the axial lengths L and L2 located in second layer 32, which may improve the ability of mattress core 10 to isolate movement when a force is applied to mattress core 10 (e.g., when someone sleeping moves while lying atop mattress system 8).

The primary support afforded by mattress core 10 may be provided by second layer 32 having a combination of spring assemblies 14 having the axial length L and the axial length L1. The springs 15 of the spring assemblies 14 having the axial length L may compress (i.e., have a lower spring constant) to a greater extent in comparison to the springs 15 of the spring assemblies 14 having the axial length L1. Thus, the spring assemblies 14 having the axial length L may compress when a force is exerted on mattress core 10 before being restricted by the spring assemblies 14 having the axial length L1. To accomplish this, the spring assemblies 14 having the axial length L1 may be positioned between spring assemblies 14 having the axial length L. In addition, it can be seen in FIG. 3 that opposing ends of the spring assemblies 14 having the axial length L1 can be spaced apart from the spring assemblies 14 having the axial length L2 located in layers 30 and 34, while the spring assemblies 14 having the axial length L are abutting the spring assemblies 14 located in layers 30 and 34. As a result, the spring assemblies 14 having the axial length L1 will not compress until contacted by the spring assemblies 14 located in layer 34. Moreover, the spaces 36 between the spring may provide increased breathability and coolness to mattress core 10.

Mattress core 10 having layers 30, 32, and 34, in addition to isolating movement, is also configured to reduce uncomfortable pressure points to provide even sleep support and alignment when mattress core 10 is being used. In addition, regardless whether mattress core 10 includes a single layer of spring assemblies 14 (FIGS. 1 and 2) or multiple layers 30, 32, and 34 of spring assemblies 14 (FIG. 3), mattress core 10 is also more breathable and cooler compared to, for example, a mattress formed of a foam such as memory foam. In this regard, the air that surrounds springs 15 in each sleeve 16 does not trap heat or dirt/dust that may accumulate during the useful life of mattress core 10, which can be up to twenty years.

As noted above, springs 15 may be formed of a material such as steel and sleeves 16 may be formed of a polymeric material such as polyethylene or polypropylene. Mattress core 10, therefore, is formed entirely or at least substantially entirely of recyclable materials. The term “substantially” indicates that at least ninety-five percent of the mattress core 10 is recyclable or made with recycled materials, which provides a mattress core 10 that does not require disposal in a landfill. Accordingly, when it is time to replace mattress core 10, the mattress core 10 may be shredded, the springs 15 can be separated from the polymeric material of sleeves 16, and each of the springs 15 and polymeric sleeves 16 can be recycled separately. In addition, it should be understood that springs 15 may be formed of recycled steel and the sleeves 16 may be formed of recycled polymeric materials. As a result, manufacture of mattress core 10 reduces the environmental impact associated with using virgin materials for these features.

As noted above, cover 12 may include a comfort layer 18, a backing layer 20, and a covering layer 22. Similar to mattress core 10, cover 12 is designed to be entirely recyclable and periodically replaceable. In this regard, cover 12 may be exposed to fluids that are either spilled or excreted. Indeed, during use of mattress system 8, cover 12 may be exposed to and collect dead skin, body oils, and moisture that can increase the weight of cover 12 up to and even exceed six pounds per year. Notwithstanding, cover 12 is designed to provide a seal relative to mattress core 10 such that these materials do not reach mattress core 10 to increase the useful life of mattress core 10.

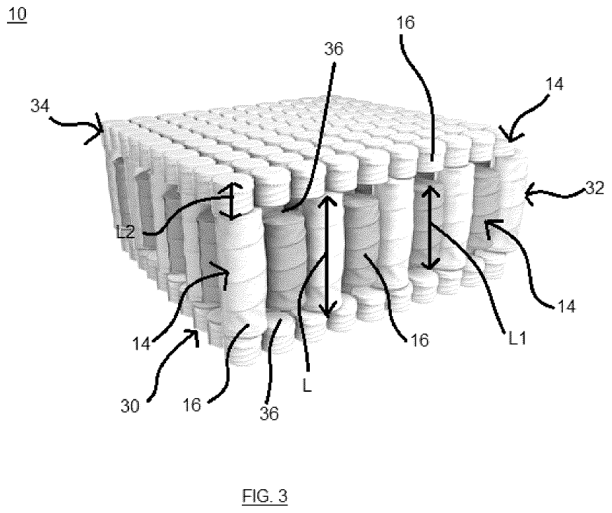

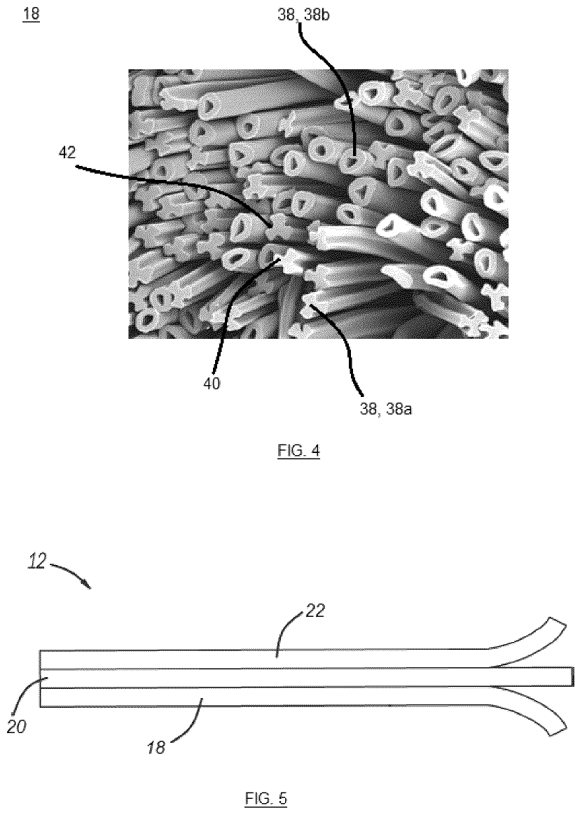

Comfort layer 18 is configured to act as a pillowtop layer that increases the comfort of mattress system 8. As best shown in FIG. 4, comfort layer 18 may be formed of a plurality of fibers 38 including a plurality of fibers 38a that are lobed and a plurality of fibers 38b that are hollow. In the illustrated embodiment, fibers 38a include a plurality of lobes 40 that extend along an axial length of fibers 38a. While fibers 38a are illustrated as having three lobes 40, it should be understood that a greater or lesser number of lobes 40 may be used without departing from the scope of the present disclosure.

Fibers 38a and 38b may be formed of a recycled or virgin polymeric material such as polypropylene or polyester such that comfort layer 18 is entirely recyclable. Fibers 38a and 38b may be randomly dispersed throughout comfort layer 18 (i.e., non-woven), or fibers 38a and 38b may be woven. In either case, the cross-section (i.e., lobed or hollow) of fibers 38a and 38b are configured to dampen noise and enhance moisture management. Moreover, because fibers 38a are lobed, the fibers 38a have an increased surface area, volume, and void ratio that increases structural integrity and wicking to provide support and plush comfort. The lobed fibers 38a are efficient at wicking moisture because the moisture can travel along the longitudinal channels 42 located between the lobes 40, which also beneficially assists in controlling odors that may be retained by cover 12. In addition to enhancing moisture management, comfort layer 18 increases the cooling and breathable properties of cover 12 and is naturally anti-bacterial and anti-fungal.

Cover 12 also includes backing layer 20 positioned between comfort layer 18 and covering layer 22. Backing layer 20 may be formed of a sustainable fiber material such as viscose (i.e., rayon), or may be formed of a polymeric material. Viscose is a semi-synthetic raw material that is derived from wood pulp (i.e., biodegradable and/or recyclable), configured to absorb moisture, and has a good climate-regulating properties similar to natural fibers such as cotton or wool. With respect to its ability to absorb moisture, viscose can absorb up to four hundred percent of its own weight in moisture, which is fifty percent more than natural fibers such as cotton. Notwithstanding its ability to absorb moisture, viscose can rapidly dry such that backing layer 20 does not retain the moisture and is breathable.

The viscose fibers of backing layer 20 may be infused with silica to provide backing layer 20 with flame-retardancy. By using silica to increase flame-retardancy of the backing layer 20, the use of flame-retardant chemicals that may be toxic are avoided during the manufacture of backing layer 20. In addition, while viscose is an absorbent material and is naturally anti-bacterial and anti-fungal, it should be understood that the viscose fiber material may also be blended with activated charcoal fibers for additional moisture control and odor absorption.

Covering layer 22 including top panel 24, bottom panel 26, and the plurality of side panels 28 is configured to naturally prevent bacterial and fungal growth (which can assist in odor management) and may be formed of a moisture-wicking fabric that is recyclable and naturally flame retardant. For example, covering layer 22 can be formed of a non-woven fabric including, for example, a plurality of polyethylene or polyester fibers. Forming covering layer 22 from these types of materials, which are naturally anti-bacterial and anti-fungal, naturally flame retardant, and moisture wicking, enables one to stay cool on warms days and evenings and reduces the effects of perspiring while sleeping (e.g., relief from night-sweats and hot flashes). These materials also assist with preventing or at least minimizing odor retention, especially if covering layer 22 is further treated with additional anti-microbial and/or anti-fungal agents.

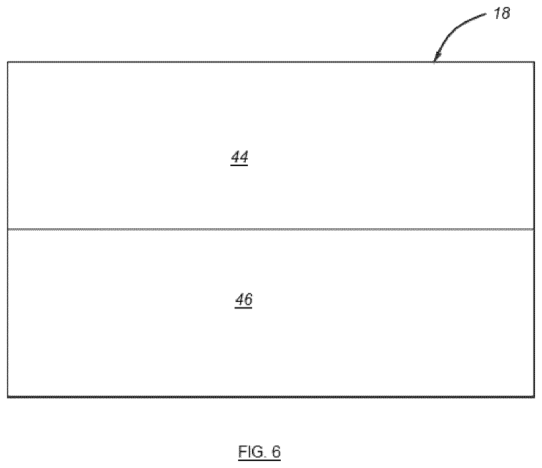

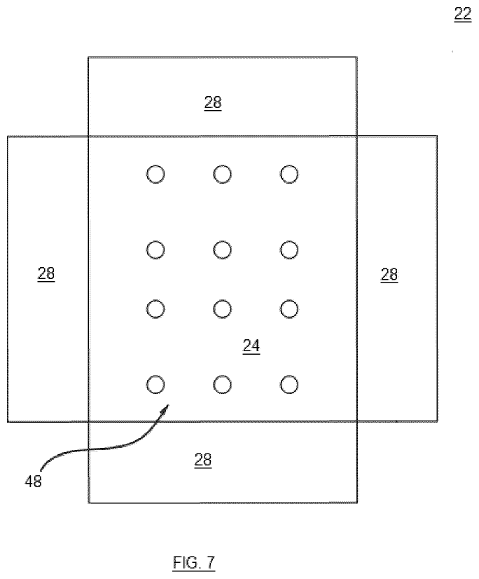

Cover 12 is preferably non-quilted and comfort layer 18, backing layer 20, and covering layer 20 are laminated to fuse the layers 18, 20, and 22 together (see, e.g., FIG. 6). The layers 18, 20, and 22 may be fused together by a heat-activated adhesive along with applying pressure to the laminate to mold the non-quilted cover 12 to the desired thickness. Notwithstanding each of the layers 18, 20, and 22 being adhesively connected (e.g., laminated), the cover 12 can still be recycled. Because non-quilted cover 12 includes at least one layer (e.g., comfort layer 18) of nonwoven fibers 38, it should be understood that the feel and density of non-quilted cover 12 may be tunable.

As noted above, the nonwoven fibers 38 of comfort layer 18 and covering layer 22 are preferably formed of a polymeric material such as polyester, polyethylene, or a combination thereof. Comfort layer 18 and covering layer 22 may be “tunable” in that a density of the nonwoven fibers 38 can be selected based on the desired stiffness of the cover 12. Although cover 12 only requires a single comfort layer 18 and single covering layer 22, it should be understood that a plurality of layers 18 and 22 can be stacked upon one another in a thickness direction of the cover 12, if desired. In such a configuration, the different comfort layers 18 and/or different covering layers 22 may each be formed of the same material (e.g., polyester or polyethylene), or the different comfort layers 18 and covering layers 22 can be formed of different materials (e.g., layer(s) of polyester and layer(s) of polyethylene). It is also contemplated that the different comfort layers 18 and covering layers 22 can have different densities to further allow variable tuning of the cover 12. The “density” of the nonwoven fibers 38 can be adjusted by increasing or decreasing an amount of the nonwoven fibers 38 per unit volume, or by increasing or decreasing the thickness (e.g., diameter) or molecular weight of each respective nonwoven fiber 38. Moreover, backing layer 18 may also be tunable regardless whether backing layer 18 is formed of viscose or a polymeric material. If backing layer 18 is not formed of polymeric fibers but rather viscose fibers, it should be understood that the density of these fibers can also be adjusted to “tune” the backing layer as well, and also backing layer 18 may also be formed of a plurality of layers having different densities, etc.

In addition, in larger mattress cover sizes such as queen- and king-sized mattress covers 12, the densities of the comfort layer(s) 18 of the cover 12 can be varied on opposing sections 44 and 46 (i.e., the left and right sides of the cover 12 (see FIG. 6)) such that a person that desires a stiffer section (e.g., at 44) of the mattress cover 12 can have comfort layer(s) 18 selected to provide the increased stiffness, while another person that desires a less stiff section (e.g., at 46) of the cover 12 can have comfort layer(s) 18 selected to provide the lower stiffness. Although only two sections 44 and 46 are illustrated, it should be understood that cover 12 can have a greater number of tunable sections, as desired.

After lamination, cover layer 22 may be heat embossed. Embossing is a process of stamping an aesthetic pattern onto the covering layer 22. In the present embodiment, the covering layer 22 may be stamped using a heated stamper that heats the covering layer 22 to melt the polymers of the fibers of the covering layer 22 and impart a pattern of aesthetically pleasing tufts 48. While only top panel 24 is illustrated as having the pattern of embossed tufts 48, it should be understood that side panels 28 may also include a pattern of tufts 48 if desired. This process provides a more permanent and defined appearance to covering layer 22. Moreover, it should be understood that the embossing process also embosses the comfort layer 18 and the backing layer 20. Alternatively, each of the covering layer 22, comfort layer 18, and backing layer 20 may be separately embossed using the above-described process.

It should also be understood that there are many advantages to heat embossing layers 18, 20, and 22 rather than sewing a conventional quilted cover. In particular, embossing covering layer 22 or each of the layers 18, 20, and 22 only requires a dwell time of about 30 seconds, while sewing a conventional quilted cover can take up to ten times longer. In addition, embossing only requires one die (stamper) that ensures consistency amongst multiple covers 12 because the same stamp is used to make each cover 12. In contrast, sewing a conventional quilted cover requires hundreds of needles that regularly break, which can decrease the consistency amongst multiple conventional quilted covers. Broken needles also require cause maintenance downtime, which negatively affects productivity.

Cover 12 has a wide variety of applications. In a medical setting, for example, cover 12 may be placed between the patient and the mattress core 10 to increase the comfort of the patient and reduce the risk that pressure sores will develop, as well as provide a sealing function that prevents fluids that are spilled or secreted from the patient from reaching the mattress core 10. In a residential setting, as noted above, the cover 12 may be used to increase the comfort of the sleeper, and also may be used to hide imperfections in the underlying mattress core 10.

According to the above description, each of mattress core 10 and cover 12 are entirely recyclable and formed of materials that are more breathable, better at wicking away moisture, odor-resistant, hypoallergenic, and tunable to adjust the comfort of bedding system 8. Mattress system 8 including cover 12 and core 10, therefore, can provide significantly improved sleep quality and comfort. Moreover, because bedding system 8 is entirely recyclable, the cover 12 and core 10 can be recycled rather than disposed of in a landfill, which reduces the environmental impact associated with manufacturing and using bedding system 8.

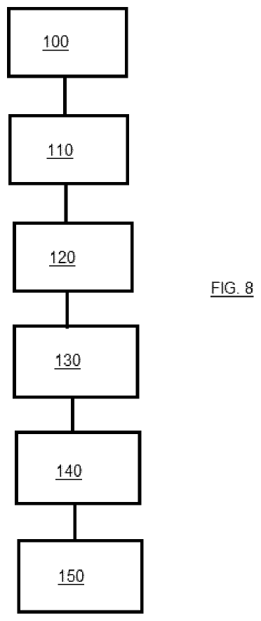

To ensure that bedding system 8 is recycled rather disposed of in a landfill, bedding system 8 may be available as part of a subscription-based service as will be described in more detail below. In this regard, referring to FIG. 8, a customer first determines that it necessary to obtain a bedding system 8 including mattress 10 and mattress cover 12 (block 100). After determining that a bedding system 8 is necessary, the customer then selects a mattress core 10 for purchase (step 110), including providing the manufacturer with desired characteristics such as, for example, a size of the core 10 (e.g., twin, full, queen, king, etc.), a desired stiffness of core 10, whether there are multiple zones of stiffness, and the like.

Then the customer selects a cover 12 to be used in combination with mattress core 10 (block 120). Similar to the selection of mattress core 10, the customer provides the manufacturer with desired characteristics for cover 12 such as a desired stiffness of comfort layer 18, whether the comfort layer 18 has multiple zones of stiffness, and the like. In addition, the customer may select whether to use a cover 12 having a covering layer 22 that is embossed or colored. Other options may include whether covering layer 22 is treated with an anti-microbial agent, and whether backing layer 20 includes a blend of charcoal fibers for moisture and odor absorption.

When selecting mattress core 10 and cover 12, it should be understood that the selection process may be conducted at a retail location or on-line through a manufacturer or retailer website.

It should be understood that while mattress core 10 can be purchased, cover 12 is not purchased and is the primary subject of the subscription service. By having cover 12 be the primary subject of the subscription service, the cover 12 can be regularly replaced by a new cover 12 that is shipped to the customer at predetermined intervals of time or as deemed fit by the customer (block 130), the customer can return the used cover 12 to the manufacturer in a package that is shipped to the customer along with the new cover 12 (block 140), and then the manufacturer will receive the used cover 12 and ensure that the used cover 12 is recycled (block 150).

Regular replacement of cover 12 is desirable from the standpoint that, as stated previously, the sleep quality and comfort of the cover 12 will decline as the cover 12 ages and because cover 12 during use thereof will be exposed to and collect dead skin, body oils, and moisture that can increase the weight of cover 12 up to and even exceed six pounds per year. Accordingly, as part of the subscription service and assuming that no modifications (e.g., different stiffness, anti-microbial properties, etc.) to the cover 12 are required by the customer, a new cover 12 may preferably be sent to the customer every year and no less than every two years. This time period is variable, and a new cover 12 may be sent to the customer every six months, every eighteen months, or as deemed fit by the customer, if desired. The time period may be customer dependent, and longer durations may be associated with lower fees. If the customer desires modification to the cover 12 before it is time for replacement, the customer may contact the manufacturer and request a new cover 12 with the desired modifications, at which time the manufacturer will receive in return the used cover 12 for recycling.

Alternatively, the subscription service may also include sending periodic reminders to the customer. For example, if cover 12 is due to be replaced after twelve months of use, the manufacturer may send a reminder to the customer after, for example, ten months of use to provide notice to the customer that a new cover 12 will be forthcoming and the customer should determine whether to modify or maintain the selected options for cover 12. These reminders can be sent via post, electronic mail, text message, and the like. Preferably, these reminders are sent electronically via electronic mail or text message.

The fees charged for the subscription service may include an upfront cost of purchasing mattress core 10 and selection of the desired cover 12. The subscription service may then periodically charge the customer for replacement of cover 12. The periodic charges may be monthly or yearly. In any event, the primary aspect to keep in mind is that mattress core 10 is manufactured to have a useful life of at least twenty years such that mattress core 10 does not require annual replacement. It should be understood, however, that mattress core 10 can be replaced and recycled based on customer request. Moreover, to the extent that cover 12 is configured to prevent or at least minimize fluids, dust, debris, and the like from reaching mattress core 10, the useful life of mattress core 10 may be further extended such that only replacement of cover 12 is necessary. In addition, because cover 12 is replaced regularly, the customer routinely experiences a fresh, healthier, and chemical-free sleep environment. Further, obtaining bedding system 8 using the subscription service is far less expensive over time that replacing an entire premium mattress that does not include a replaceable cover that can be recycled.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A bedding system subscription service, comprising:
providing a selection of mattress cores from which a customer can select for purchase;
providing a selection of mattress covers from which the customer can select for use in combination with the selected mattress core;
periodically replacing the selected mattress cover with a new mattress cover; and
recycling the selected mattress cover after it has been replaced by the new mattress cover.

2. The bedding system subscription service according to claim 1, wherein the step of periodically replacing the selected mattress cover with the new mattress cover includes shipping the new mattress cover to the customer after the selected mattress cover has been in use for a predetermined period of time.

3. The bedding system subscription service according to claim 2, wherein the shipping the new mattress cover to the customer further comprises shipping a return package to the customer with the new mattress cover for the customer to return the selected mattress cover for the recycling.

4. The bedding system subscription service according to claim 2, wherein the predetermined period of time is six months, one year, eighteen months, or two years.

5. The bedding system subscription service according to claim 1, further comprising sending a reminder to the customer in advance of periodically replacing the selected mattress cover with the new mattress cover.

6. The bedding system subscription service according to claim 1, wherein the selection of mattress cores and the selection of mattress covers include mattress cores and mattress covers that are entirely recyclable.

7. The bedding system subscription service according to claim 1, wherein the selection of mattress cores and the selection of mattress covers include mattress cores and mattress covers that are formed of recycled materials.

8. The bedding system subscription service according to claim 1, wherein the mattress cores include a plurality of individual spring assemblies that each including a spring enveloped in a sleeve.

9. The bedding system subscription service according to claim 8, wherein the plurality of individual spring assemblies include first spring assemblies having a first axial length, second spring assemblies having a second axial length, and third spring assemblies having a third axial length, wherein the first axial length is greater than the second axial length, and the second axial length is greater than the third axial length.

10. The bedding subscription service according to claim 8, wherein each spring is formed of a recycled metal material and each sleeve is formed of a recycled polymeric material.

11. The bedding subscription service according to claim 1, wherein mattress covers each include a backing layer, a comfort layer, and a covering layer that are each recyclable.

12. The bedding subscription service according to claim 11, wherein the comfort layer is formed from a plurality of fibers that are configured to enhance moisture management and increase cooling and breathable properties of the mattress cover.

13. The bedding subscription service according to claim 12, wherein the plurality of fibers include hollow elongated fibers and elongated fibers that include a plurality of lobes that extend along a length of the elongated fibers.

14. The bedding subscription service according to claim 13, wherein a density of the plurality of fibers is tunable to adjust a stiffness of the comfort layer.

15. The bedding subscription service according to claim 11, wherein the backing layer is flame retardant and formed of a breathable moisture absorbent material that is biodegradable and odor resistant.

16. The bedding subscription service according to claim 11, wherein the covering layer is formed of a recyclable polymeric material that is moisture wicking.

17. The bedding subscription service according to claim 16, wherein the covering layer is embossed by heating.

18. The bedding subscription service according to claim 16, wherein the covering layer further comprises an anti-bacterial and anti-fungal agent.
